(19) United States
(12) Patent Application Publication
(10) Pub. No.: US 2026/0208859 A1
(43) Pub. Date: Jul. 23, 2026

(54) PROPULSOR DRIVE SHAFT WITH BRANCHED PORTION

(71) Applicant: BETA AIR LLC, South Burlington, VT (US)

(72) Inventors: Riley Clinton Griffin, Montpelier, VT (US); Mark Eric Rakowitz, Saint-Laurent (CA); Read Ferguson Frost, Burlington, VT (US); Amine Ben Haj Ali, Ottawa (CA)

(21) Appl. No.: 19/035,617

(22) Filed: Jan. 23, 2025

(51) Int. Cl. B64C 27/78; B64C 27/20

(52) U.S. Cl. CPC B64C 27/78; B64C 27/20; B64C 27/43

(57) ABSTRACT

The present invention relates to a drive shaft including a motor interfacing portion, a propulsor interfacing portion, and an intermediate branched portion. The present invention further relates to a drive shaft including a motor interfacing portion, a propulsor interfacing portion, and a non-cylindrical cross-section configured to reduce drag when a longest dimension of the non-cylindrical cross-section is aligned with a direction of air flow, the non-cylindrical cross-section configured to rotate with the drive shaft.

### FIELD

The present disclosure relates to a drive shaft for a lift propulsor on an aircraft.

### BACKGROUND

Aircraft may employ one or more propulsor assemblies to lift an aircraft vertically or propel an aircraft forward. In some aircraft configured for vertical takeoff and landing operation, at least one propulsor assembly may provide lift for the aircraft during a vertical takeoff, vertical landing, and/or hovering phase/operation, and at least another may provide forward thrust during a forward flight mode of operation. Aircraft may encounter problematic drag when a propeller assembly designed for lift is used during forward flight mode, a propeller assembly designed for forward thrust is used during vertical flight mode, or when either is used during transition between flight mode.

### SUMMARY

The present disclosure describes a novel drive shaft for a propulsor assembly for an aircraft that includes at least one of a branched portion or a non-cylindrical cross-section configured to reduce drag. The branched portion and/or non-cylindrical cross-section of the drive shaft may reduce drag over prior drive shafts when a propulsor assembly is in a stowed position and the airflow is predominantly orthogonal to the rotational axis of the drive shaft, as may occur, for example, when a lift propeller assembly is stowed during forward flight mode.

In some aspects, the techniques described herein relate to a drive shaft including: a motor interfacing portion; a propulsor interfacing portion; and a branched portion positioned between the motor interfacing portion and the propulsor interfacing portion.

In some aspects, the techniques described herein relate to a drive shaft including: a motor interfacing portion; a propulsor interfacing portion; and a non-cylindrical cross-section configured to reduce drag when a longest dimension of the non-cylindrical cross-section is aligned with a direction of air flow, the non-cylindrical cross-section configured to rotate with the drive shaft.

### BRIEF DESCRIPTION OF THE DRAWINGS

FIG. 1 depicts a perspective view of an example aircraft, according to an example;

FIG. 2 depicts an example propulsor assembly coupled to an aircraft, according to an example;

FIG. 3 depicts an example propulsor assembly coupled to an aircraft, according to an example;

FIG. 4A depicts a perspective view of a portion of a propulsor assembly with a fairing, according to an example;

FIG. 4B depicts a bottom perspective view of a portion of a propulsor assembly, according to an example;

FIG. 4C depicts a top perspective view of a portion of the portion of the propulsor assembly, according to an example;

FIG. 4D depicts a top view of a propulsor assembly with detail view, according to an example;

FIG. 4E, depicts a bottom detail view of the detail from FIG. 4D, according to an example;

FIG. 4F depicts a cross sectional view of a coupling assembly, cut along the cross sectional line C-C indicated in FIG. 4D, according to an example;

FIG. 5A depicts a perspective view of the branched portion of a drive shaft, according to an example;

FIG. 5B depicts an upper view of the drive shaft, according to an example;

FIG. 5C depicts a left view of the branched portion of the drive shaft, according to an example; and

FIG. 5D depicts a cross sectional view of the branched portion of the drive shaft through the cross sectional line D-D indicated in FIG. 5C.

FIG. 6 depicts a cross sectional view of a coupling assembly for the motor shaft depicted in FIG. 3.

### DETAILED DESCRIPTION

Aircraft and other vehicles may incorporate one or more propulsor assemblies to provide thrust. A propulsor assembly includes a blade and a drive shaft that is coupled to a rotating motor. In examples, a propeller assembly may operate as a lift propulsor, providing vertical thrust to operate the vehicle during a vertical flight mode, i.e., a vertical takeoff mode of operation and/or a vertical landing mode of operation and/or hover mode of operation and/or a transition phase of flight in which the vehicle is transitioning between vertical and forward flight modes. In examples, a propulsor assembly may operate as a forward propulsor, generating forward thrust to operate the vehicle in a forward flight mode, or a fixed wing flight mode.

In one example of a vertical takeoff and landing (VTOL) vehicle, an aircraft may include at least a lift propulsor assembly dedicated to vertical flight mode and at least a forward propulsor assembly dedicated to forward flight mode. The lift propulsor assembly may operate during portions of vertical takeoff and landing while the forward propulsor is stowed, and the forward propulsor assembly may be operated during forward flight mode while the lift propulsor assembly is stowed. Such aircraft have a transitional mode where the aircraft operates in both flight modes, e.g., transitioning from vertical flight mode to forward flight mode or vice versa.

During a transitional mode, both the lift propulsor assembly and the forward propulsor assembly may be operated simultaneously to manage the transitions between the vertical flight and the forward flight modes.

When an aircraft has a propulsion assembly dedicated to predominantly providing only vertical or horizontal thrust, however, that propulsion assembly may experience edgewise flight conditions. To mitigate edgewise flight conditions, a teeter mechanism may be incorporated into the propulsor assembly, allowing the blade to pivot, or flap, relative to a rotational axis of the blade. The teeter mechanism, as will be further described below, may allow the blade to pivot or flap in response to environmental operating conditions.

Fairings are used on aircraft to reduce drag by housing less aerodynamic aircraft components behind more airfoil-like shapes. For example, a drive shaft and a motor may be housed in a fairing to reduce drag and increase the aircraft efficiency. When a teeter mechanism is incorporated into the junction between a blade and a drive shaft in a propulsor assembly, however, the fairing around the motor must accommodate the full range of movement of the pivoting blade. To accommodate the moving blade, some portion of the drive shaft often must be exposed. It is a technical problem that an exposed drive shaft for a propulsor assembly can create drag and reduce the efficiency of flight.

Solutions provided in the present disclosure include a drive shaft for a propulsor assembly with at least one of a branched section and/or a non-cylindrical cross section (i.e., an airfoil) to reduce drag across the drive shaft. In examples, the propeller assembly may be in a stowed position. In examples, a branched portion may be configured to allow fluid to flow through the drive shaft. In examples, one or more sections of the drive shaft, including the branched portion, may have an airfoil cross sectional shape. In examples, the portions of the branched section may be staggered with respect to one another. In examples, the drive shaft may include a stiffening member coupled between branched portions of the drive shaft.

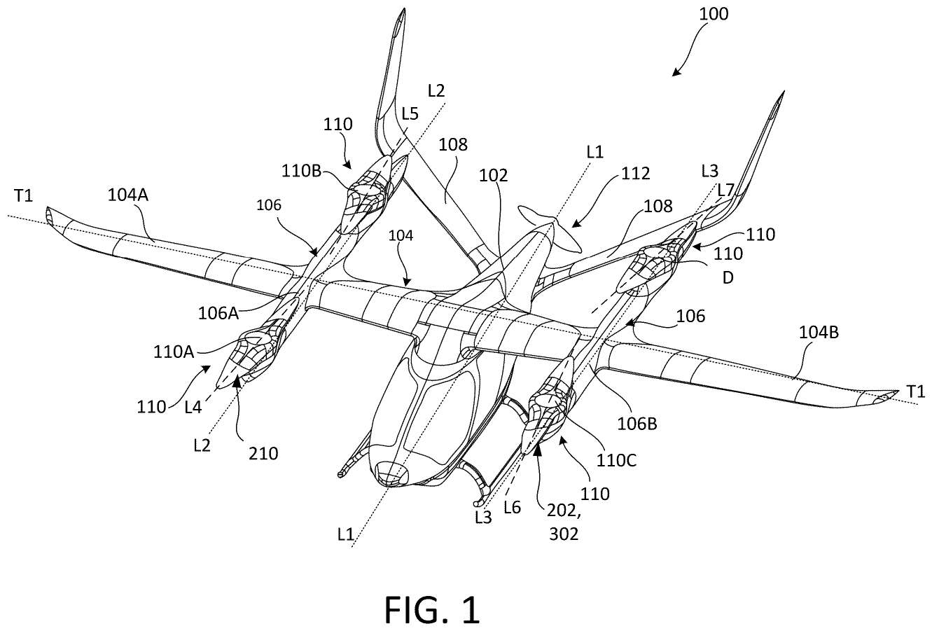

FIG. 1 is a perspective view of an example aircraft 100, a VTOL-type aircraft. The example aircraft 100 shown in FIG. 1 includes a main body, or fuselage 102. In the example arrangement shown in FIG. 1, laterally extending structural elements, or wings 104, extend outward from opposite lateral side portions of the fuselage 102, in a somewhat transverse arrangement with respect to the fuselage 102. In some examples, a single wing 104 extends across the fuselage 102 and laterally outward from opposite lateral side portions of the fuselage 102. In some examples, the wing 104 includes a first wing 104A extending laterally outward from a first lateral side of the fuselage 102, and a second wing 104B extending laterally outward from a second lateral side of the fuselage 102. A cross-sectional geometry of the wings 104 and/or portions thereof may have a contour corresponding to an airfoil shape, such that a pressure differential between a lower surface and an upper surface of the wing 104 generates lift during flight of the example aircraft 100. In some examples, control surfaces (not separately labeled in FIG. 1) may be provided on the wings 104, and controlled by a pilot to maneuver the example aircraft 100, for example, when in a wing-borne phase of flight.

In example of aircraft 100, the wings 104 are fixed relative to the fuselage 102, and symmetrically arranged with respect to a longitudinal axis L1 of the example aircraft 100. The wings 104 extend along an axis T1, the axis T1 being transverse to the longitudinal axis L1. In the example arrangement shown in FIG. 1, a pair of longitudinally extending structural elements, or booms 106, extend longitudinally, between a respective portion of the wing 104 and a tail structure 108 at an aft portion of the fuselage 102. In this example, a first boom 106A of the pair of booms 106 is aligned along a longitudinal axis L2, separated from the longitudinal axis L1, and transverse to the axis T1, and a second boom 106B of the pair of booms 106 is aligned along a longitudinal axis L3, separated from the longitudinal axis L1 of the fuselage 102, and transverse to the axis T1. The example arrangement of the fuselage 102, the wings 104, the booms 106, and the tail structure 108 of the example aircraft 100 shown in FIG. 1 is provided simply for purposes of discussion and illustration. The concepts to be described herein are applicable to other types of aircraft, including different structural components and/or combinations of components, arranged similarly to or differently from what is shown in FIG. 1.

In the example arrangement shown in FIG. 1, the example aircraft 100 includes a plurality of propulsor assemblies 110. In this example arrangement, the plurality of propulsor assemblies 110 are configured to generate vertical thrust for operation of the example aircraft 100 in a thrust borne or vertical flight mode. In some examples, the plurality of propulsor assemblies 110 may be controlled such that operation of the plurality of propulsors can provide for operation of the example aircraft in the forward flight mode. In the example arrangement shown in FIG. 1, a first propulsor assembly 110A and a second propulsor assembly 110B are each coupled to a motor positioned on the first boom 106A, and a third propulsor assembly 110C and a fourth propulsor assembly 110D are each coupled to a motor positioned on the second boom 106B, simply for purposes of discussion and illustration. The principles to be described herein are applicable to other numbers and/or combinations and/or arrangements of propulsor assemblies.

In the example arrangement shown in FIG. 1, the example aircraft 100 includes at least one propulsor assembly 112 configured to generate forward thrust for operation of the example aircraft 100 in the forward flight mode, or fixed wing flight mode. In the fixed wing flight mode, the example aircraft 100 uses lift provided by the wings 104 in combination with the forward thrust/forward airspeed generated by the at least one propulsor assembly 112. In the example arrangement shown in FIG. 1, the at least one propulsor assembly 112 is coupled at an aft end portion of the fuselage 102, for operation as a pusher propulsor, simply for purposes of discussion and illustration. The principles described herein are applicable to arrangements in which a forward thrust propulsor is provided at a different location on the aircraft, and/or in which more than one forward thrust generating propulsor is provided and/or at different locations on the aircraft and/or in different orientation(s) on the aircraft.

In some examples, the aircraft 100 is a vertical takeoff and landing (VTOL) aircraft. In some examples, the aircraft 100 is an electric vertical takeoff and landing (eVTOL) aircraft, in which the propulsor assemblies 110, 112 are driven by at least one power source (not separately labeled in FIG. 1). Hereinafter, simply for purposes of discussion and illustration, operation of the propulsor assemblies 110, 112 of the example aircraft 100 will be described with respect to at least one electric motor (not separately labeled in FIG. 1), simply for purposes of discussion and illustration. The principles described herein are applicable to other types of aircraft, however, including, for example, unmanned aerial vehicles (UAVs), drones, other types of rotorcraft, and the like, which can be powered by various different power sources including, for example, electric motors, conventionally fueled motors, and/or a combination thereof. In examples, the principles described herein may be applicable to other vehicles that use propulsors as well.

In general, electric motors convert electrical energy into mechanical energy, for example by causing a shaft to rotate. In some examples, an electric motor may be driven by direct current (DC) electric power. In some examples, an electric motor may be driven by electric power having varying or reversing voltage levels, such as alternating current (AC) electric power as produced by an alternating current generator and/or inverter. In some examples, electronic speed controllers and/or other such components may regulate motor speed, direction of rotation, torque output, dynamic braking, and other such operational characteristics of an electric motor.

Examples of electric motors include, for example, brushless DC electric motors, permanent magnet synchronous motors, switched reluctance motors, induction motors, and the like.

In some examples, aircraft 100 includes an energy source (not separately labeled in FIG. 1) configured to provide energy to the at least one power source. In an example in which the power source is an electric motor, the at least one energy source may include, for example, at least one battery, or a plurality of batteries connected so as to meet an energy or power requirement for a particular flight plan or series of flight plans of the example aircraft 100. In some examples, the example aircraft 100 incorporates other types of energy sources, instead of, or in addition to, a plurality of batteries, including, for example, a generator, a photovoltaic device, a fuel cell (e.g., a hydrogen fuel cell, direct methanol fuel cell, a solid oxide fuel cell, and the like), other electric energy storage device (e.g. a capacitor, an inductor, and the like), and other such energy sources.

In some examples, the plurality of propulsor assemblies 110 are vertical propulsor assemblies configured to provide vertical thrust when operating the example aircraft 100 in the vertical flight mode, for example, in a vertical takeoff/short takeoff state, a vertical landing/short landing state, a hover state, and the like. In some examples, the at least one propulsor assembly 112 is a forward thrust propulsor assembly configured to provide forward thrust when operating the example aircraft 100 in the forward flight mode. In some examples, in the forward flight mode, at least some, or all, of the plurality of vertical thrust propulsor assemblies 110 are in a standby mode, such that the example aircraft 100 is propelled forward in response to the thrust generated by forward thrust propulsor assembly 112. When in standby mode, at least some, or all, of the plurality of vertical thrust propulsor assemblies 110 may be in a stowed position. In the stowed position, each blade associated with any combination of the propulsor assemblies 110 may have a longitudinal axis that is positioned to be substantially aligned with a respective longitudinal axis L1 or L2 to reduce drag along the blade. For example, in FIG. 1 the first propulsor assembly 110A may have longitudinal axis L4, the second propulsor assembly 110B may have the longitudinal axis L5, the third propulsor assembly 110C may have the longitudinal axis L6, and the fourth propulsor assembly 110D may have the longitudinal axis L7.

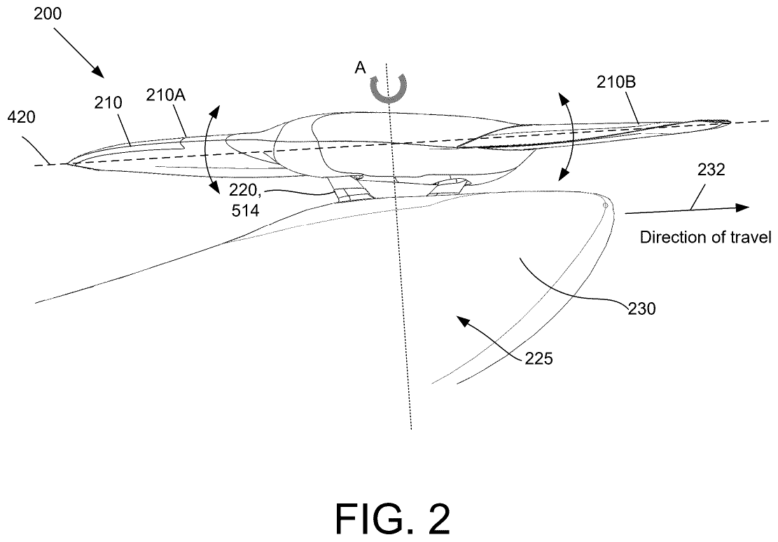

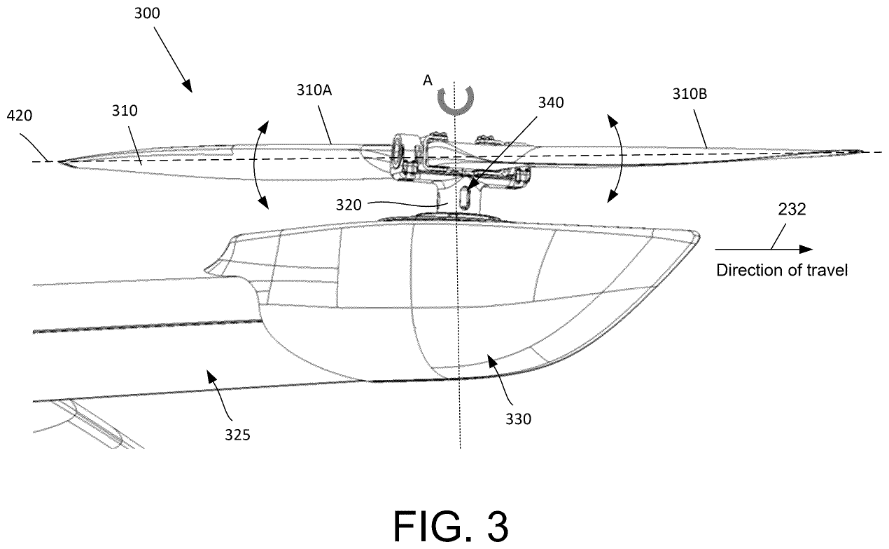

An example propulsor assembly 200 is depicted coupled to an aircraft in FIG. 2, and a further example propulsor assembly 300 is depicted in FIG. 3. The example propulsor assemblies 200, 300 may represent instances of one of the propulsor assemblies 110 of the example aircraft 100 shown in FIG. 1, or of another vehicle not explicitly shown herein. Propulsor assemblies 200 each include at least a blade 210 and a drive shaft 220. The drive shaft 220 couples the propulsor assembly 200 to a motor (not depicted). Propulsor assemblies 300 each include at least a blade 310 and a drive shaft 320. The drive shaft 320 couples the propulsor assembly 300 to a motor (not depicted).

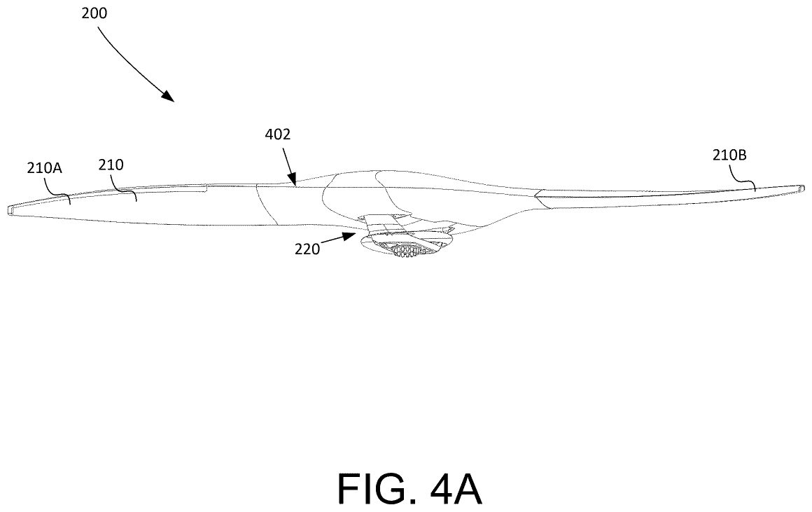

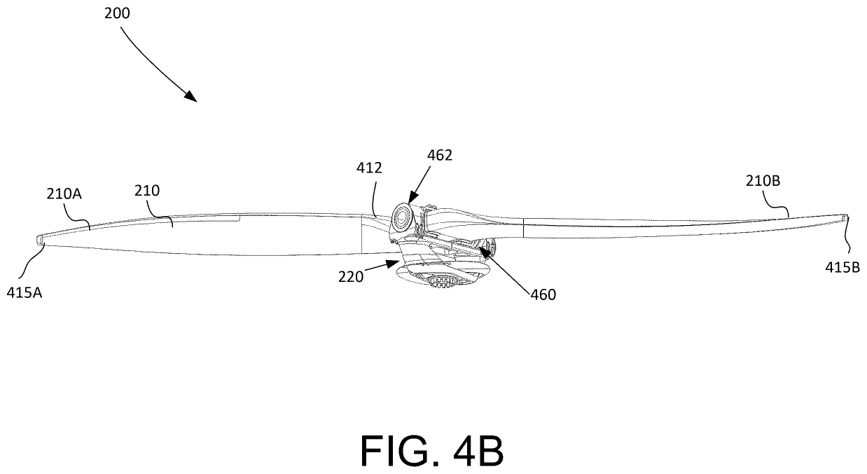

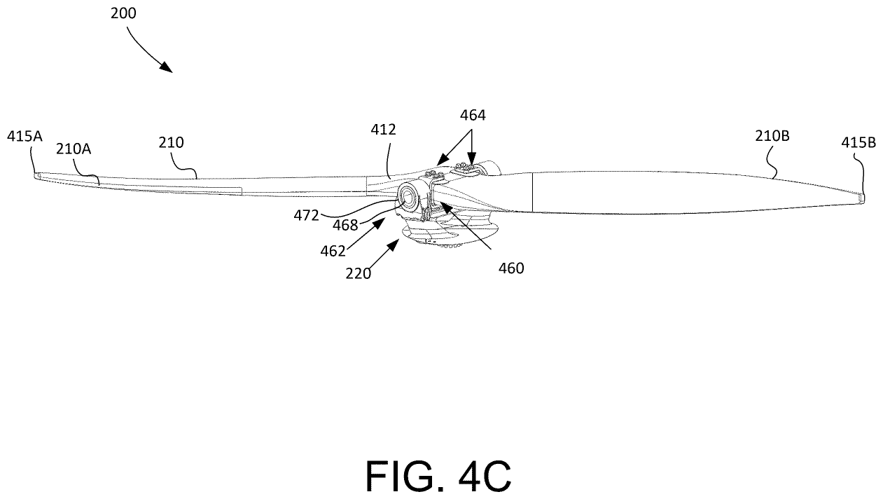

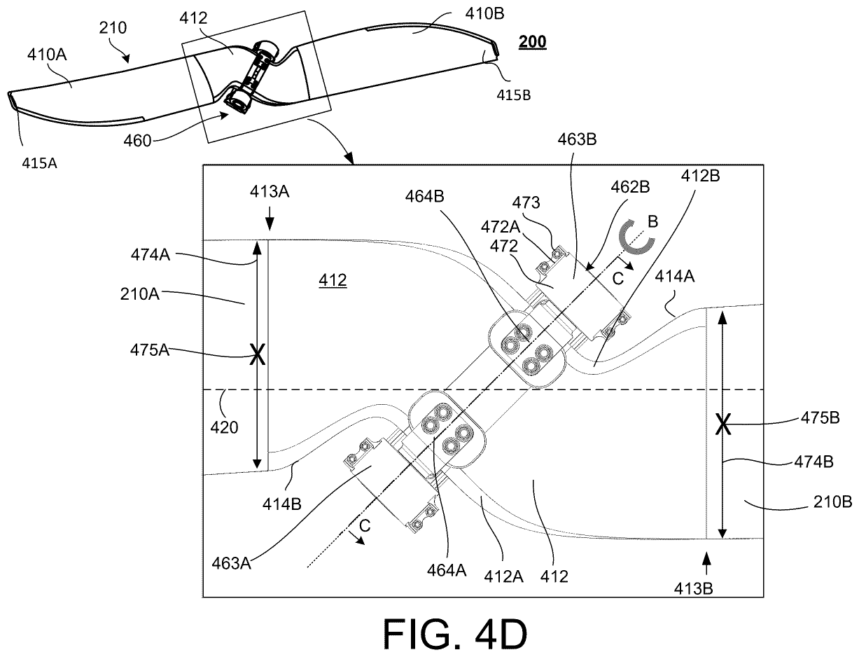

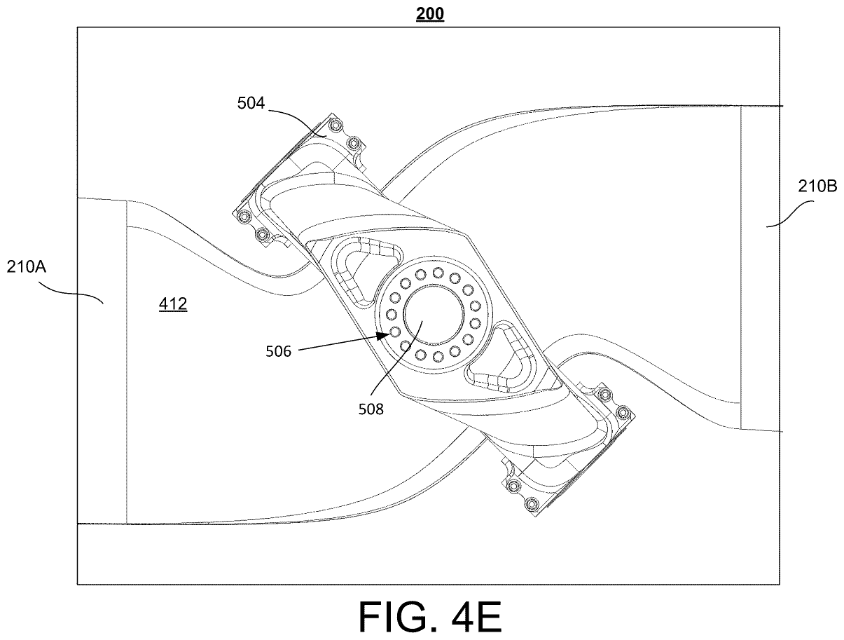

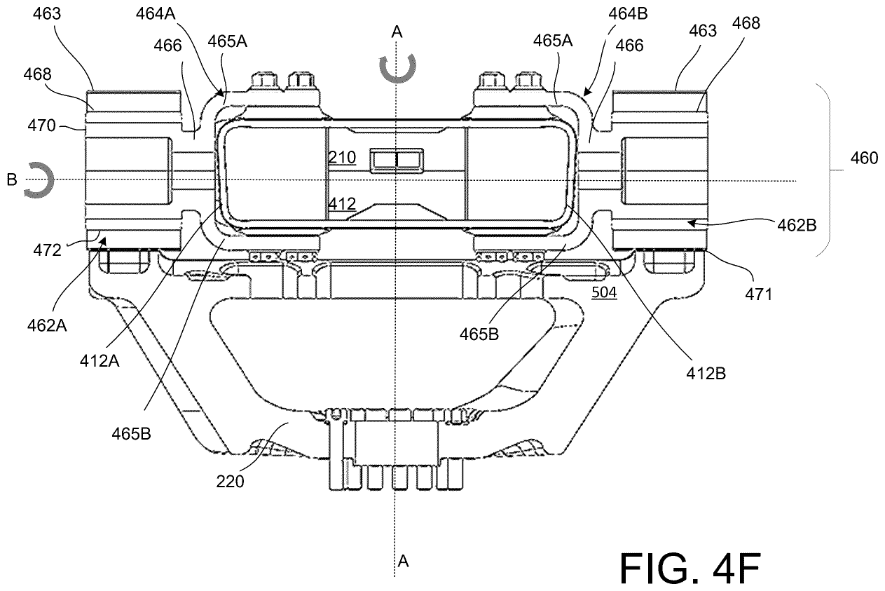

In examples, the propulsor assembly 200, 300 may include one or more blades 210, 310 coupled to a hub section that may be rotated to provide thrust. The hub section cannot be seen in FIGS. 2 and 3, but is discussed with respect to FIGS. 4B to 4F below. A blade is an element that extends in a radial dimension with respect to the rotational axis of the drive shaft 220, 320. In examples, a blade may have an airfoil cross-sectional shape. In one example, the propulsor assembly 200, 300 may include a monolithic blade including two opposing blade portions, first blade portion 210A and second blade portion 210B, that extend radially outward from a hub portion. The opposing blade portions may be rigidly coupled together or otherwise fabricated integrally with the hub section to form a monolithic structure.

In examples, the motor may be coupled to a structural element 225, 325 of aircraft 100 for example, the boom 106 of the example aircraft 100 shown in FIG. 1, or another structural element, based on a configuration of the aircraft to be powered by the propulsor assembly 200. In examples, any combination of the motor, the structural element 225, 325, and/or any portion of the blade 210, 310 may be housed within a fairing 230, 330. The fairing 230, 330 may be designed to reduce drag over what may be experienced if any combination of the structural element 225, 325 motor, and/or portion of drive shaft 220, 320 is exposed to airflow during flight.

A propulsor assembly 200, 300 may be coupled to a structural element 225, 325 with a motor providing rotational power to the blade 210, 310. The blade 210, 310 may be coupled to the motor via a drive shaft 220, 320 so that the blade 210, 310 rotates together with the motor about a drive shaft axis A. In examples, a plane of rotation of the blade 210, 310 may be substantially perpendicular to the rotational axis A of the propulsor assembly 200, 300.

At least some of the propulsor assemblies 110 may experience edgewise flight conditions, particularly as the aircraft 100 transitions between the vertical flight mode and the forward flight mode. Edgewise conditions are external forces directed at an edge portion of a propeller and may occur when aircraft 100 travels in a direction orthogonal to a rotational axis of a propulsor, causing an air stream to be directed at an edge portion of the propeller. Edgewise conditions may cause asymmetric interactions on the advancing and retreating side of the blade 210, 310, resulting in an unsteady pressure field. Excessive flapping of blade 210, 310, may also occur, which may lead to inadvertent displacement of the propeller and vibrations that affect operation of first propulsor assembly 110A, 110B, 110C, 110D and/or other aircraft structures and systems. Over time, edgewise conditions may cause stress and strain on components of the propulsor assembly and/or components as vibrations affect the long term reliability of the affected components and/or the stability of the aircraft 100.

A teeter mechanism may be incorporated into the propulsor assembly 200, 300, coupled between the drive shaft 220, 320 and blade 210, 310 to mitigate the edgewise flight conditions.

By allowing for passive teetering, pivoting, or rotation of the blade with respect to the rotational axis of drive shaft 220, 320, vibrations may be reduced during edgewise flight, thereby allowing a more stable transition between vertical and forward flight modes of operation. By attenuating vibrations of the forces exerted on the propeller or blade and reducing the transmission of those forces to the larger structure of the propulsor assembly and structural frame of the aircraft, a teeter mechanism may allow for a certain amount of up-and-down tip displacement of a blade via rotation, reducing the load experienced by the propulsor assembly. In the example of the monolithic blade depicted in FIGS. 2 and 3, the teeter mechanism may cause the plane of rotation of the blade to pivot with respect to the rotational axis of the drive shaft.

The inclusion of a teeter mechanism may require additional clearance between the propulsor assembly 200, 300 and the fairing 402 to allow for the blade 210, 310 rotation. In examples, the additional clearance may result in a drive shaft 220, 320 being exposed to airflow.

In examples, propulsor assembly 200, 300 may be used primarily for lift propulsion. In examples, propulsor assembly 200, 300 may be used during a vertical or transitional flight phase. When an aircraft is in forward flight mode, however, propulsor assembly 200, 300 may be stowed to reduce drag and save energy.

To reduce drag, the blade 210, 310 may be stowed so that a longitudinal axis 420 of the blade predominantly aligns with a direction of air flow or travel 232 of the aircraft 100. For example, any combination of the longitudinal axes LA, L5, L6, or L7 may align with the longitudinal axis L1 of the aircraft 100, as depicted in FIG. 1. By predominantly aligning the longitudinal axis of the blade 210, 310 with the fuselage of the plane, the blade 210, 310 may be aligned within 0, 2.5, 5, or 10 degrees of the predominant direction of travel or air flow. In examples, offsetting the alignment of the blade 210, 310 within 0, 2.5, 5, or 10 degrees of the direction of travel or airflow may further reduce the drag of the lift propulsor in forward flight mode. In other words, when the blade 310 is stowed, a first blade portion 210A may be substantially positioned within 0, 2.5, 5, or 10 degrees either in front of or behind a second blade portion 210B relative to the primary direction of travel of the aircraft 100.

In examples, the location of the blade 210, 310 as it rotates is determined by a position sensor (not depicted) on the motor that corresponds to a target on the drive shaft 220. In examples, the parking may be unidirectional or bidirectional.

In FIG. 4A, a perspective view of a portion of propulsor assembly 200 is provided with a fairing 402 installed. In FIG. 4B, a bottom perspective view of a portion of propulsor assembly 200 is provided; in FIG. 4C a top perspective view of a propulsor assembly 200 is provided; in FIG. 4D a top view of a portion of propulsor assembly 200 and a detail are provided; in FIG. 4E, a bottom detail view of the detail of propulsor assembly 200 from FIG. 4D is provided; and in FIG. 4F a cross sectional view of the coupling assembly 460 by cross sectional line C-C in FIG. 4D is provided.

The example propulsor assembly 200 includes a blade 210 and a drive shaft 220. In examples, propulsor assembly 200 may further include a coupling assembly 460 coupling the blade 210 to the drive shaft 220, as will be described below.

The blade 210 includes a first blade portion 210A and a second blade portion 210B, each extending radially outward from a hub section 412 of the blade 210. In examples, the hub section 412, the first blade portion 210A and the second blade portion 210B may be coupled or integrated to fabricate a continuous version of the blade 210 with an integral instance of the hub section 412. In examples, the blade 210 may include an outer structural layer that extends continuously across the first blade portion 210A, the second blade portion 210B, and the hub section 412, for example, from a tip end portion 415A of the first blade portion 210A, through the hub portion hub section 412, to a tip end portion 415B of the second blade portion 210B to create a monolithic blade structure. In some examples, due to the unitary, or monolithic structure of the blade 210, the pitch of the first blade portion 210A and the second blade portion 210B are not independently adjustable. When incorporated into a vertical lift propulsor, for example, in an application such as the example aircraft 100 described above, the vertical lift propulsors may operate as fixed pitch propulsors.

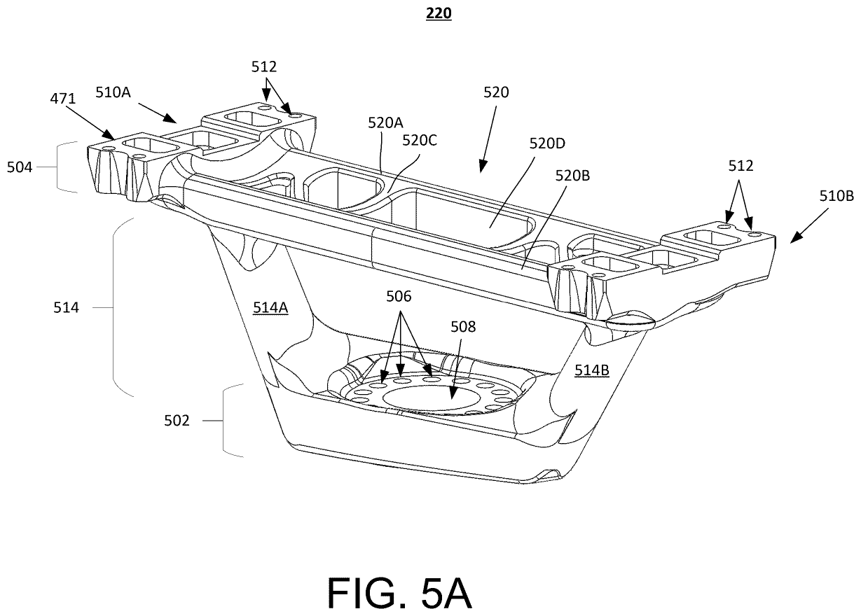

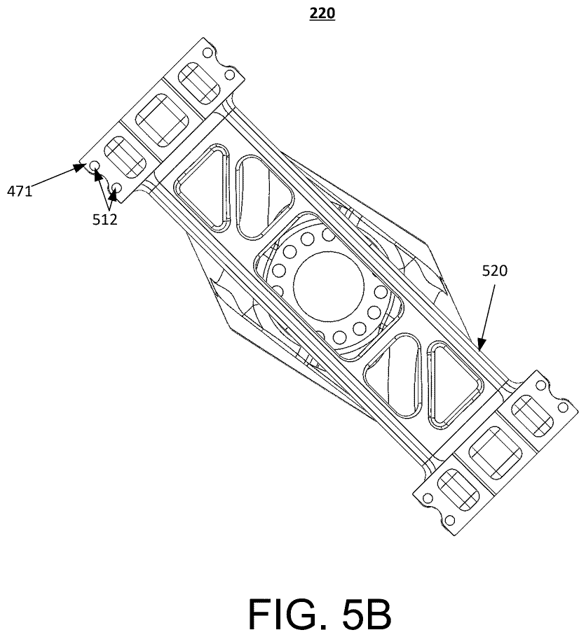

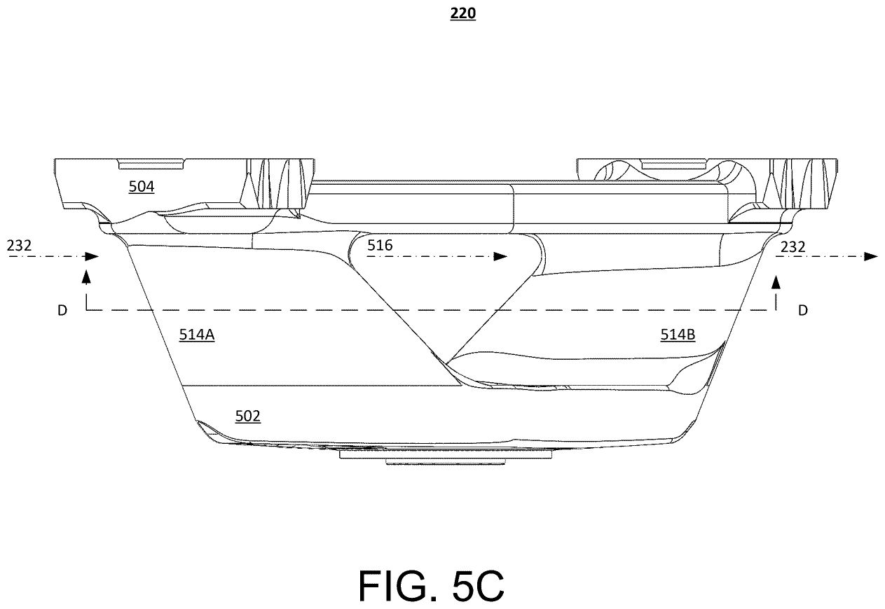

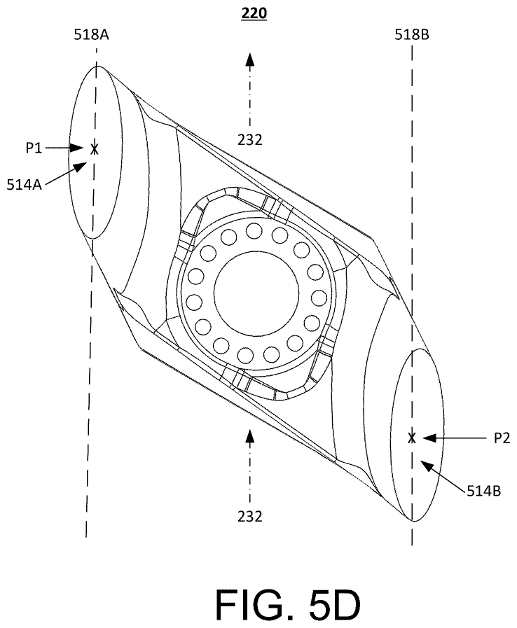

FIG. 5A depicts a perspective view of the drive shaft 220, FIG. 5B depicts an upper view of the drive shaft 220, FIG. 5C depicts a left view of the drive shaft 220, and FIG. 5D depicts a cross sectional view of the drive shaft 220 through cross sectional line D-D indicated in FIG. 5C.

Drive shaft 220 includes a motor interfacing portion 502 and a propulsor interfacing portion 504. In examples, the motor interfacing portion 502 may couple to a rotor portion of a motor (not depicted), directly or indirectly via one or more coupling members. In examples, the motor interfacing portion 502 may be substantially planar, to be coupled to a substantially planar rotating surface of a motor.

One or more apertures 506 may be positioned upon the substantially planar face of the motor interfacing portion 502 to enable the drive shaft 220 to be coupled to the motor. In the example of drive shaft 220, the one or more apertures 506 are arranged circumferentially around a central aperture 508 to facilitate the use of fasteners such as screws, bolts, rivets, anchors, and so forth. While the example of a substantially planar motor interfacing portion 502 with a circumferential configuration of one or more apertures 506 is provided, other configurations of apertures are possible. In examples, non-planar mating surfaces and alternative methods of fastening are also possible between drive shaft 220 and a motor.

In examples, the central aperture 508 may be configured to allow hot air to exit the motor, thereby cooling the motor.

The drive shaft 220 further includes the propulsor interfacing portion 504. The propulsor interfacing portion 504 is configured to couple to the blade 210. In examples, connecting the drive shaft 220 to the blade 210 may further include an intermediate coupling assembly 460, as will be described below. In examples, the coupling assembly 460 may include a teetering mechanism.

In examples, the propulsor interfacing portion 504 may be substantially planar or take any shape required to conform to the coupling assembly 460 or the blade 210. In the example depicted in the figures, propulsor interfacing portion 504 includes a first end 510A and a second end 510B opposing the first end. At each of the first end 510A and the second end 510B, there are apertures 512 configured to couple propulsor interfacing portion 504 to the coupling assembly 460 and thereby the blade 210.

In examples, the drive shaft 220 may include a branched portion 514 positioned between the motor interfacing portion and the propulsor interfacing portion. The branched portion 514 includes a first branch portion 514A and a second branch portion 514B. In examples, the branched portion 514 may be exposed to air flow. For example, as may be seen in FIG. 2, branched portion 514 may be exposed to air flow during flight because it is positioned outside of the fairing 230. In examples, the branched portion 514 may be positioned outside of any housing, cover, or shroud coupled to or surrounding any portion of any instance of the boom 106 and fully exposed to the ambient airflow outside of the aircraft 100.

In examples, the branched portion 514 of drive shaft 220 may have a yoke-like or “Y”-like shape, with the first branch portion 514A and the second branch portion 514B extending away from motor interfacing portion 502. In examples, the branched portion 514 may be configured to allow fluid to flow through the drive shaft. In examples, by allowing fluid to flow through the branched portion 514, drive shaft 220 may have less drag than other configurations of drive shaft.

Prior drive shafts may include a cylindrical cross-sectional area. When exposed to the ambient conditions, including the combination of wind and relative airflow outside of any housing or fairing of the aircraft 100, a drive shaft with a circular cross-sectional area may experience flow separation and pressure drag.

A cross-sectional view of the drive shaft 220 may be seen in FIG. 5D. In examples, the drive shaft 220 may have less drag than a drive shaft with a cylindrical cross sectional area. For example, drive shaft 220 may have less drag than a drive shaft with a cylindrical cross sectional area that has the same cross-sectional area as the cross-sectional areas of the first branch portion 514A and the second branch portion 514B separately or combined.

In examples, any combination of the first branch portion 514A and the second branch portion 514B of the drive shaft 220 may have a non-cylindrical cross-section configured to reduce drag when a longest dimension 518A, 518B of the non-cylindrical cross-section is substantially aligned with a direction of air flow. In examples, at least one of the first branch portion 514A and second branch portion 514B may include an airfoil cross-section. In examples, the blade 210 may be stowed during forward flight, for example by aligning blade 210 with a direction of travel of the aircraft 100.

The description of the drive shaft 220 with a branched portion is not intended to be limiting, however. In examples, drive shaft 220 may include a non-cylindrical cross-sectional shape without the branched portion 514 which may include any of the features described herein with respect to the first branch portion 514A and second branch portion 514B.

In examples, drive shaft 220 may be configured so that a longest dimension 518A, 518B of a non-cylindrical cross-section may be substantially aligned with a direction of travel 232 or air flow when blade 210 is stowed. For example, the longest dimension 518A, 518B of a non-cylindrical cross-section of the first branch portion 514A or the second branch portion 514B may be substantially aligned with a direction of air flow when it is within 10, 5, or 2.5 degrees parallel to the direction of air flow. For example, in FIGS. 5C and 5D it may be seen that air flow in the direction of travel 232 will pass through drive shaft 220 between first branch portion 514A and second branch portion 514B. In FIG. 5D, a longest dimension 518A of first branch portion 514A and a longest dimension 518B of first branched portion 514B are depicted with broken lines. The air flow 516 is substantially aligned with longest dimension 518A and longest dimension 518B. Aligning the longest dimension(s) of the non-cylindrical cross-section(s) with the direction of travel and/or air flow may reduce drag and maximize the air flow through the branched portion 514.

In one example, the longest dimension 518A, 518B of a non-cylindrical cross-section of the first branch portion 514A or the second branch portion 514B may be aligned with a direction of travel 232 while the longitudinal axis 420 is offset five degrees from the direction of travel 232.

Turning to FIG. 5A, the first branch portion 514A may be coupled to the first end 510A of the propulsor interfacing portion 504, and the second branch portion 514B may be coupled to the second end 510B of the propulsor interfacing portion 504.

In examples, a stiffening member 520 may be coupled between the first branch portion 514A and the second branch portion 514B. In examples, stiffening member 520 may be coupled between the first end 510A and the second end 510B of the propulsor interfacing portion 504.

The stiffening member 520 may be configured to increase the stiffness or rigidity between the first end 510A and the second end 510B of the propulsor interfacing portion 504, which may reduce the natural frequency of the drive shaft 220. In the example of FIG. 5A, the stiffening member 520 includes a first edge 520A and a second edge 520B that run parallel to a longitudinal axis of the stiffening member 520. The first edge 520A and the second edge 520B may be connected via one or more ribs 520C. Between the one or more ribs 520C are one or more openings 520D that may accommodate a technician assembling the drive shaft 220 to the motor by providing access to the one or more apertures 506. In other examples, the stiffening member 520 may comprise a substantially planar surface, or one or more rods, or any other shape operable to connect the first branch portion 514A and the second branch portion 514B and/or the first end 510A and the second end 510B.

In examples, the drive shaft 220 may be fabricated by machining titanium or aluminum. In examples, other materials and fabrication techniques are contemplated.

In examples, the first branch portion 514A and second branch portion 514B of the stiffening member 520 may be staggered or positioned at different locations along an axis aligned with a longest dimension of a cross-sectional area of at least one of the first branch portion and the second branch portion. For example, turning to FIG. 5D, it may be seen that first branch portion 514A is centered at a first position P1 and second branch portion 514B is centered at a second position P2, and the first position P1 and the second position P2 are at different locations along either of longest dimensions 518A, 518B. In examples, the first branch portion 514A and second branch portion 514B may be staggered with respect to a direction of travel when the blade 210 is in a stowed position.

In examples, staggering the first branch portion 514A with respect to the second branch portion 514B along an axis aligned with a longest dimension 518A, 518B of a cross-sectional areas of first branch portion 514A and/or second branch portion 514B may reduce drag by creating a favorable pressure interaction between the first branch portion 514A and the second branch portion 514B. Staggering the first branch portion 514A and the second branch portion 514B may avoid separation by allowing the pressure fields of the first branch portion 514A and the second branch portion 514B mutually interact in a favorable fashion, much like a multi-element air flow with wing and a flap or a wing with a winglet attached at the aft end of the wing tip. In examples, the first branch portion 514A and the second branch portion 514B may be staggered so that the propulsor interfacing portion 504 is better oriented to couple to an s-shaped hub section 412, as is further described below.

FIG. 3 depicts a further example drive shaft 320. Instead of the yoke-like shape of the branched portion 514, the drive shaft 320 may feature a branched portion with a duct passage 340 through drive shaft 320. In examples, the duct passage 340 may be rounded where the duct passage meets the face of the exterior surface of drive shaft 320 to decrease drag. The duct passage 340 may be formed in such a way that it has a full circumference that passes through the drive shaft 320. In examples, drive shaft 320 may include any of the features described with respect to drive shaft 220 herein.

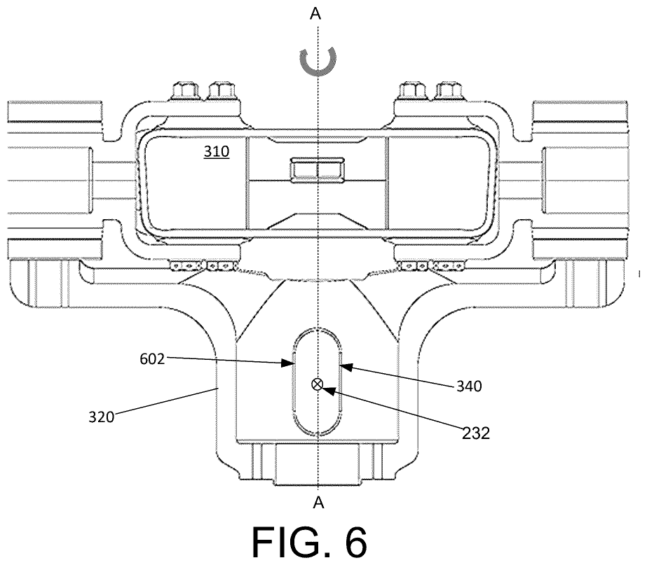

FIG. 6 depicts a cross sectional view (including the same orientation described for FIG. 4F above) of a coupling assembly with the drive shaft 320 depicted in FIG. 3. In the example, the duct passage 340 has an oval cross-sectional shape that includes an oval-shaped first opening 602 in the surface of the drive shaft 320 and an oval-shaped second opening (not depicted) on an opposite side of the surface of the drive shaft 320. In further examples other cross-sectional shapes of duct passage 340 are possible, however.

In examples, when the blade 310 is in a stowed position the oval-shaped first opening 602 may be substantially aligned with the second opening (not depicted) of the duct passage 340 in the direction of travel 232 (coming out of the page in FIG. 6). This may maximize air flow through the duct passage 340 and minimize drag across the drive shaft 320.

In examples, the duct passage 340 may be positioned outside of any fairing, housing, cover, or shroud. In examples, the duct passage 340 may be positioned above an outer edge of the boom or any other housing structure coupled to the boom. In examples, the duct passage 340 may be fully exposed to the airflow outside of the aircraft 100.

Returning to the example propulsor assembly 200 of FIGS. 2, 4A-5D for illustration, the coupling assembly 460 may connect the hub section 412 of the blade 210 to the motor via the propulsor interfacing portion 504 of the drive shaft 220. The coupling assembly 460 may include bearings 462 and brackets 464. In examples, the coupling assembly 460 may incorporate a teetering mechanism into propulsor assembly 200.

A perspective view of the brackets 464 and bearings 462 of the coupling assembly 460 may be seen in the of FIG. 4C. In the top view of FIG. 4D, it may be seen that the brackets 464 include a first bracket 464A and a second bracket 464B, which secure to opposing sides of the hub section 412. A bearing housing may also be seen that includes a first bearing housing 463A and a second bearing housing 463B at opposite ends of the hub section 412.

In the cross-sectional view of FIG. 4F, the positions of the brackets 464, the blade 310, the bearing housing 463, and the propulsor interfacing portion 504 of the drive shaft 220 may be seen. The coupling assembly 460 may include two bearings, a first bearing 462A and a second bearing 462B to facilitate the pivoting of the teetering mechanism. The bearings 462 may be mounted on the propulsor interfacing portion 504 of drive shaft 220 at positions corresponding to opposite side portions of the hub section 412 of the blade 210.

A first bracket 464A and a second bracket 464B may be mounted on opposing sides of the hub section 412, the first side portion 412A and the second side portion 412B respectively, to pivotably couple the blade 210 to the motor via the propulsor interfacing portion 504. A first bearing 462A may be coupled between the propulsor interfacing portion 504 and the first bracket 464A, and a second bearing 462B may be coupled between the propulsor interfacing portion 504 and the second bracket 464B.

Each of the first bracket 464A and second bracket 464B may include a u-shaped arrangement of arm portions that extend from a center portion 466 toward the hub section 412 of the blade 210. A first arm portion 465A may extend from the center portion 466, configured for coupling to an upper surface of the hub section 412 of the blade 210. A second arm portion 465B may extend from the center portion 466, configured for coupling to a lower surface of the hub section 412. The first side portion 412A and the second side portion 412B of the hub section 412 may each be received between a respective first arm portion 465A and second arm portion 465B of a respective bracket 464. In examples, one or more fasteners may be used to couple the first arm portion 465A and the second arm portion 465B to the hub section 412. Other methods may be used to couple a bracket 464 to the hub section 412 of the blade 310, however.

It may be seen in FIG. 4C that the bearings 462 may include an inner housing 468 and an outer housing 472. Returning to FIG. 4F, each respective bracket 464 may include a bearing coupling portion 470 on an end of the center portion 466 opposite the first arm portion 465A and second arm portion 465B. The bearing coupling portion 470 of the bracket 464 may be received in the inner housing 468. In the example, the inner housing 468 includes a cylindrical inner surface and the bearing coupling portion 470 and inner housing 468 fit concentrically together.

In further examples, however, non-cylindrical surfaces are contemplated, however. In examples, the bearing coupling portion 470 may be press fit into the inner housing 468. In examples, the bearings 462 may include respective biasing members configured to do one or more of centering and/or dampening the rotations of the teetering mechanism.

In examples, the propulsor interfacing portion 504 of drive shaft 220 may be coupled to a propulsor assembly coupling surface 471 of the outer housing 472 of the bearings 462. In FIG. 4D, it may be seen that outer housing 472 visible on a top side of the propulsor assembly 200 includes a side tab region 472A on either side of the bearing, the side tab region 472A positioned to align with a radial direction of the axis A. In the example, the side tab region 472A includes one or more apertures 473 for fasteners to couple the bearings 462 to the propulsor interfacing portion 504. Other methods of fastening are contemplated, however, such as clamping, using adhesive, and so forth.

Turning to FIG. 5A, it may be seen that the propulsor assembly coupling surface 471 may include two surfaces at the first end 510A and the second end 510B configured to be coupled to the bearings 462. The first end 510A and the second end 510B may be configured to couple to the outer housing 472 of the bearings 462, for via the apertures of side tab region 472A.

Turning to FIG. 4F, it may be seen that the coupling assembly 460 between the blade 210 and the drive shaft 220 allows the blade 210 to rotate via the motor around the rotational axis of the drive shaft 220, axis A, while also allowing the blade 210 to pivot or teeter around a teetering axis B. This may allow the blade 210 to respond to edgewise forces while also generating thrust.

FIG. 4D depicts an example instance of the blade 210 with an s-shaped hub section 412. The s-shape is defined by the edge contoured edge portion 414A and contoured edge portion 414B, which form two s-shaped opposing edges between surfaces of the hub section 412.

A longitudinal axis 420 of the blade 210 is depicted with a dotted line. It may be noted that a center point 475A of a length 474A of the first blade portion 210A at the junction 413A between the hub section 412 and the first blade portion 210A is offset from a center point 475B a length 474B of the second blade portion 210B at the junction 413B between the hub section 412 and the second blade portion 210B.

The s-shape of the hub section 412 changes the angle at which the bearings 462 of the teeter mechanism may be coupled to the blade 210. In examples, the angle between the teeter axis B and the longitudinal axis 420, along with the offset between the center point 475A and the center point 475B, may help form a negative feedback loop for the blade 210 to naturally provide pitch variation. In examples, the feedback loop may augment any retarding, or restoring moment due to the biasing, or centering force, or restoring force, applied by biasing members or centering members of the bearings 462.

In order to accommodate connection to the s-shaped hub section 412 via an angled teeter mechanism, the first branch portion 514A and second branch portion 514B of the drive shaft 220 may be staggered with respect to the longest dimension 518A, 518B of a cross-sectional area of the first branch portion 514A and/or second branch portion 514B.

The foregoing description has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations are not to be regarded as a departure from the disclosure, and all such modifications are intended to be included within the scope of the disclosure.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example implementations.

Spatially relative terms, such as “inner,” “outer,” “beneath,” “below,” “lower,” “above,” “upper,” “bottom,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In some aspects, the techniques described herein relate to a drive shaft, wherein the branched portion of the drive shaft has a first branched portion including a non-cylindrical cross-section configured to reduce drag when a longest dimension of the non-cylindrical cross-section is aligned with a direction of air flow.

In some aspects, the techniques described herein relate to a drive shaft, wherein the branched portion includes a first branch portion and a second branch portion, and the propulsor interfacing portion is configured to couple the first branch portion to a first end of the propulsor interfacing portion and to couple the second branch portion to a second end of the propulsor interfacing portion.

In some aspects, the techniques described herein relate to a drive shaft, the propulsor interfacing portion includes a stiffening member coupled between the first branch portion and the second branch portion.

In some aspects, the techniques described herein relate to a drive shaft, wherein the first branch portion and the second branch portion are positioned at different locations along an axis aligned with a longest dimension of a cross-sectional area of at least one of the first branch portion and the second branch portion.

In some aspects, the techniques described herein relate to a drive shaft, wherein at least one of a first branch portion or a second branch portion of the branched portion includes an airfoil cross-section.

In some aspects, the techniques described herein relate to a drive shaft, wherein the branched portion is configured to allow fluid to flow through the drive shaft.

In some aspects, the techniques described herein relate to a drive shaft, wherein the branched portion is exposed to air flow.

In some aspects, the techniques described herein relate to a propulsor assembly including: the drive shaft; a motor coupled to the motor interfacing portion; a blade coupled to the propulsor interfacing portion; and a teeter mechanism coupled between the propulsor interfacing portion and the blade operable to allow the blade to rotate out of a plane perpendicular to a rotational axis of the drive shaft.

In some aspects, the techniques described herein relate to a drive shaft, wherein the drive shaft generates vertical thrust on a vertical takeoff and landing aircraft during a vertical flight mode and is stowed during a forward flight mode.

In some aspects, the techniques described herein relate to a drive shaft, wherein the non-cylindrical cross-section is an airfoil.

In some aspects, the techniques described herein relate to a drive shaft, further including:
a branched portion positioned between the motor interfacing portion and the propulsor interfacing portion.

In some aspects, the techniques described herein relate to a drive shaft, wherein the branched portion includes a first branch portion and a second branch portion, and the propulsor interfacing portion is configured to couple the first branch portion at a first end of the propulsor interfacing portion and to couple the second branch portion at a second end of the propulsor interfacing portion.

In some aspects, the techniques described herein relate to a drive shaft, wherein the branched portion is configured to allow fluid to flow through the drive shaft.

In some aspects, the techniques described herein relate to a drive shaft, further including: a stiffening member coupled between the first branch portion and the second branch portion.

In some aspects, the techniques described herein relate to a drive shaft, wherein the first branch portion and the second branch portion are positioned at different locations along an axis aligned with the longest dimension of a cross-sectional area of at least one of the first branch portion and the second branch portion.

In some aspects, the techniques described herein relate to a drive shaft, wherein the branched portion is exposed to air flow.

In some aspects, the techniques described herein relate to a drive shaft, wherein the drive shaft is included on an electric vertical takeoff and landing aircraft each generating vertical thrust.

In some aspects, the techniques described herein relate to a propulsor including: the drive shaft; a motor coupled to the motor interfacing portion; a blade coupled to the propulsor interfacing portion; and a teeter mechanism coupled to the propulsor interfacing portion operable to allow the blade to rotate out of a plane perpendicular to an axis of rotation of the drive shaft.

1. A drive shaft comprising:
a motor interfacing portion;
a propulsor interfacing portion; and
a branched portion positioned between the motor interfacing portion and the propulsor interfacing portion, wherein the branched portion comprises a first branch portion and a second branch portion and wherein the first branch portion and the second branch portion are offset along an axis aligned with a longest dimension of a cross-sectional area of at least one of the first branch portion and the second branch portion and wherein the first branch portion and the second branch portion are inclined away from each other along said axis and wherein at least one of a first branch portion or a second branch portion of the branched portion includes an airfoil cross-section.

2. The drive shaft of claim 1, wherein the branched portion of the drive shaft has a first branched portion including a non-cylindrical cross-section configured to reduce drag when a longest dimension of the non-cylindrical cross-section is aligned with a direction of air flow.

3. The drive shaft of claim 1, and the propulsor interfacing portion is configured to couple the first branch portion to a first end of the propulsor interfacing portion and to couple the second branch portion to a second end of the propulsor interfacing portion.

4. The drive shaft of claim 3, the propulsor interfacing portion includes a stiffening member coupled between the first branch portion and the second branch portion.

5. (canceled)

6. (canceled)

7. The drive shaft of claim 1, wherein the branched portion is configured to allow fluid to flow through the drive shaft.

8. The drive shaft of claim 1, wherein the branched portion is exposed to air flow.

9. A propulsor assembly comprising:
the drive shaft of claim 1;
a motor coupled to the motor interfacing portion;
a blade coupled to the propulsor interfacing portion; and
a teeter mechanism coupled between the propulsor interfacing portion and the blade operable to allow the blade to rotate out of a plane perpendicular to a rotational axis of the drive shaft.

10. The drive shaft of claim 1, wherein the drive shaft generates vertical thrust on a vertical takeoff and landing aircraft during a vertical flight mode and is stowed during a forward flight mode.

11. A drive shaft comprising:
a motor interfacing portion;
a propulsor interfacing portion; and
a non-cylindrical cross-section configured to reduce drag when a longest dimension of the non-cylindrical cross-section is aligned with a direction of air flow, the non-cylindrical cross-section configured to rotate with the drive shaft, wherein the non-cylindrical cross-section is an airfoil, and wherein the non-cylindrical section is angled at a non-right angle along an axis aligned with a longest dimension of the cross-sectional area.

12. The drive shaft of claim 11, wherein the non-cylindrical cross-section is an airfoil.

13. The drive shaft of claim 11, further comprising:
a branched portion positioned between the motor interfacing portion and the propulsor interfacing portion.

14. The drive shaft of claim 13, wherein the branched portion comprises a first branch portion and a second branch portion, and the propulsor interfacing portion is configured to couple the first branch portion at a first end of the propulsor interfacing portion and to couple the second branch portion at a second end of the propulsor interfacing portion.

15. The drive shaft of claim 13, wherein the branched portion is configured to allow fluid to flow through the drive shaft.

16. The drive shaft of claim 14, further comprising:
a stiffening member coupled between the first branch portion and the second branch portion.

17. The drive shaft of claim 14, wherein the first branch portion and the second branch portion are positioned at different locations along an axis aligned with the longest dimension of a cross-sectional area of at least one of the first branch portion and the second branch portion.

18. The drive shaft of claim 13, wherein the branched portion is exposed to air flow.

19. The drive shaft of claim 11, wherein the drive shaft is included on an electric vertical takeoff and landing aircraft each generating vertical thrust.

20. A propulsor comprising:
the drive shaft of claim 11;
a motor coupled to the motor interfacing portion;
a blade coupled to the propulsor interfacing portion; and
a teeter mechanism coupled to the propulsor interfacing portion operable to allow the blade to rotate out of a plane perpendicular to an axis of rotation of the drive shaft.
